(19) United States
(12) Patent Application Publication
(10) Pub. No.: US 2002/0101914 A1
(43) Pub. Date: Aug. 1, 2002

(54) Extended reach VDSL

(76) Inventor: Sabit Say, Parsippany, NJ (US)

Correspondence Address: IP STRATEGIES, P.C., 806 7 th St. , NW, SUITE 301, WASHINGTON, DC, 20001, US

(21) Appl. No.: 09/770,661

(22) Filed: Jan. 29, 2001

(51) Int. Cl. H04B 1/38; H04L 5/16

(52) U.S. Cl. 375/222

(57) ABSTRACT

A method for providing data service to locations an extended distance from an access network includes generating a downstream signal, providing the downstream signal to a first transmitter and a second transmitter, transmitting the downstream signal over media to a location, generating an upstream signal, providing the upstream signal to a first receiver and a second receiver, and receiving the upstream signal over the media from the location. A transceiver for use in an access network providing data services includes a media connecting the access network to a location, a first transmitter for transmitting a first signal at a first frequency, a second transmitter for transmitting the first signal at a second frequency, a first receiver for receiving a second signal at a third frequency, and a second receiver for receiving the second signal at a fourth frequency.

### BACKGROUND OF THE INVENTION

The telephone local loop composed of twisted wire pairs and which was originally used to transport analog telephone services, is now being used for high-speed video and data services. High-speed transport over twisted wire pair uses xDSL-based transmission techniques which include Asymmetric Digital Subscriber Line (ADSL), High-bit rate Digital Subscriber Line (HDSL), Rate Adaptive Digital Subscriber Line (RADSL), and Very high speed Digital Subscriber Line (VDSL).

These transmission techniques use the upper frequencies of the twisted wire pair's spectrum to deliver services. In particular, VDSL uses a frequency band plan based on the Frequency Division Duplexing wherein the spectrum allowed for VDSL transmission (i.e. the spectrum from 0.138 MHz to 12 MHz) is divided into 2 pairs of frequency bands. A first pair occupying the lower portion of the available spectrum comprises a first downstream frequency band and a first upstream frequency band and a second pair, which occupies the upper portion of the spectrum, comprises a second downstream frequency band and a second upstream frequency band.

The twisted wire pair transmission medium is subject to attenuation and distortion due to cross-talk and other signal impairments. The higher portion of the spectrum is more severely affected by the distortion and the attenuation, which is function of the distance and the frequency. The path characteristics of the twisted wire pair constitute a limitation to the distance that can be reached by a VDSL system.

For the foregoing reasons, there is a need for a method and apparatus for extending the reach of VDSL-based transmission systems.

### SUMMARY OF THE INVENTION

The present invention relates to a method and system for extending the reach of VDSL-based services using a frequency band plan based upon the frequency division duplexing.

A method, in accordance with one embodiment of the present invention, for providing data service to locations at extended distance from an access network is disclosed. The method comprising the steps of (1) generating a downstream signal; (2) providing the downstream signal to a first transmitter and a second transmitter; (3) transmitting the downstream signal over media to a location; (4) generating an upstream signal; (5) providing the upstream signal to a first receiver and a second receiver; and (6) receiving the upstream signal over the media from the location. The downstream signal from the first transmitter may be transmitted over a first twisted wire pair and the downstream signal from the second transmitter may be transmitted over a second twisted wire pair.

In another embodiment, a transceiver for use in an access network providing data services is disclosed. The transceiver includes: (1) a media connecting the access network to a location; (2) a first transmitter for transmitting a first signal at a first frequency; (3) a second transmitter for transmitting the first signal at a second frequency; (4) a first receiver for receiving a second signal at a third frequency; and (5) a second receiver for receiving the second signal at a fourth frequency.

These and other features and objects of the invention will be more fully understood from the following detailed description of the preferred embodiments which should be read in light of the accompanying drawings.

### BRIEF DESCRIPTION OF THE DRAWINGS

The accompanying drawings, which are incorporated in and form a part of the specification, illustrate the embodiments of the present invention and, together with the description serve to explain the principles of the invention.

In the drawings:

FIG. 1 represents a variety of configurations for XDSL transmission systems

FIG. 2 represents a VDSL spectrum allocation

FIG. 3 illustrates a transceiver unit for use with the VDSL spectrum allocation; and

FIG. 4 illustrates a configuration which allows an extended reach VDSL.

### DETAILED DESCRIPTION OF THE PREFERRED EMBODIMENT

In describing a preferred embodiment of the invention illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose.

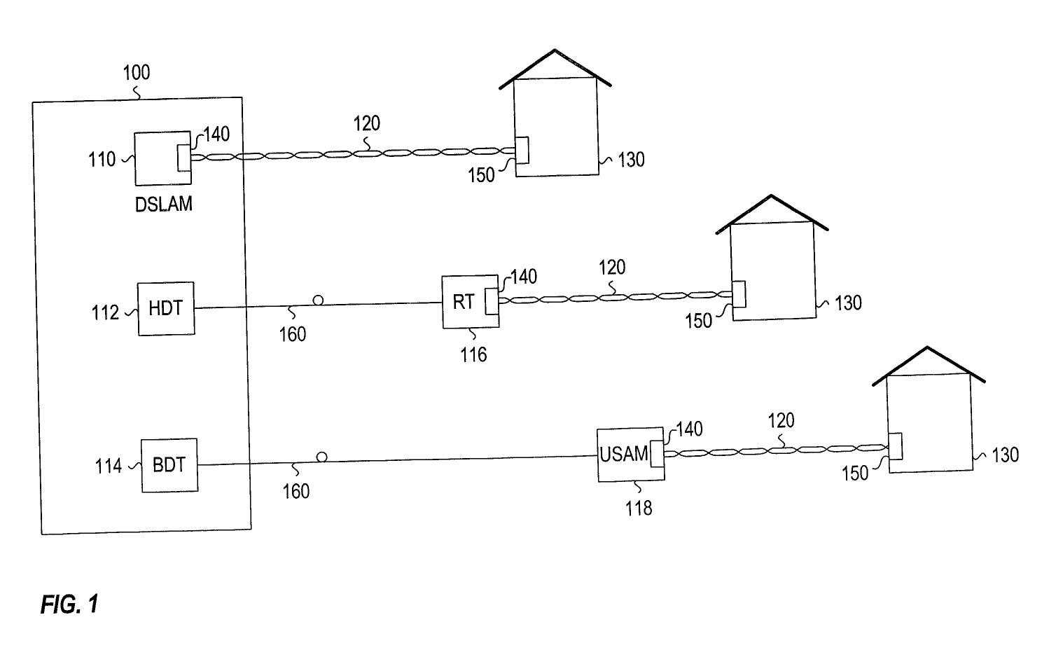

With reference to the drawings, in general, and FIGS. 1 through 4 in particular, the apparatus of the present invention is disclosed.

Referring to FIG. 1, a variety of types of central office equipment can be located in central office 100. This equipment includes a digital subscriber line access multiplexer (DSLAM) 110, a host digital terminal (HDT) 112 and a broadband digital terminal (BDT) 114.

Referring to DSLAM 110, a XDSL transceiver unit central (XTU_{C})140 located in DSLAM 110 connects to twisted wire pair 120 and transmits and receives signals to an xDSL transceiver unit remote (XTU_{R}) 150 which is located in residence 130. Alternatively, (XTU_{R}) 150 can be located in a building or other location distant from the central office.

In another embodiment, the host digital terminal 112 is connected to a remote terminal (RT) 116 via an optical fiber 160. A variety of signals including data, video and voice signals can be transmitted over optical fiber 160 and are received at (RT) 116 where they are transformed into a DSL signal which is transmitted by (XTU_{C})140 over the twisted wire pair 120 to (XTU_{R}) 150.

Referring to BDT 114, data, voice and video signals can be transmitted over an optical fiber 160 to a universal service access multiplexer (USAM) 118 where the signals are received and placed in a format suitable for transmission from (XTU_{C})140 over twisted wire pair 120 to (XTU_{R}) 150 located in residence 130 or in another building or location remote from the central office.

Referring to FIG. 1, the DSLAM 110, HDT 112, and BDT 114 embodiments are generally utilized differently and according to the distance between the residence and the central office. In certain applications, the distance between the central office 100 and the residence 130 may be short enough that a DSLAM 110 can be used with a direct twisted wire pair connection 120 to the residence 130. In other instances, the distance is such that a remote terminal 116 supported by HDT 112 via optical fiber 160 is utilized to place (XTU_{C})140 closer to the residence 130. In yet other embodiments, a BDT 114 is used in conjunction with USAM 118 and optical fiber 160 to place (XTU_{C})140 within roughly 3,000 feet of residence 130.

All of the above embodiments can be utilized with a variety of digital subscriber line (DSL) technologies. These technologies include, but are not limited to, systems such as asymmetric digital subscriber line (ADSL), symmetric digital subscriber line (SDSL), rate adaptive digital subscriber line (RADSL), and very high speed digital subscriber line (VDSL). These technologies, along with other DSL type technologies, are generally referred to as xDSL transmission technologies. Thus it can be seen from FIG. 1 that XDSL technologies support the transmission of data to residences which may be at varying distance from the central office.

One of the issues with respect to xDSL systems is that some xDSL systems require the use of the high frequency spectrum on the twisted pair 120. An example of this are VDSL systems which typically utilize the spectrum from 0.138 to 12 MHz.

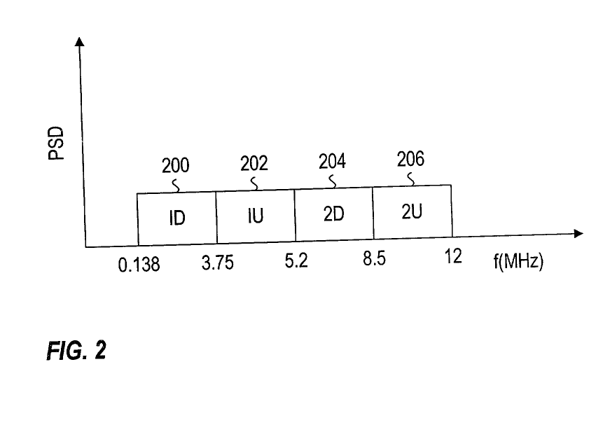

An example of a VDSL frequency plan is the one shown in FIG. 2 in which a first downstream frequency band 200 extends from 0.138 to 3.75 MHz, a first upstream frequency band 202 extends from 3.75 MHz to 5.2 MHz, a second downstream frequency band 204 extends from 5.2 MHz to 8.5 MHz and a second upstream frequency band 206 extends from 8.5 MHz, to 12 MHz. This frequency band plan for VDSL has been proposed because it can allow the transmission of signals in the low frequency regions of the band, specifically using first downstream frequency band 200 and first upstream frequency band 202 and can achieve a longer reach because attenuation at these frequencies is lower than the attenuation at the frequencies above 5.2 MHz. Using this frequency plan, if the distance between the central office 100 and the residence 130 and the length of the twisted wire pair 120 is such that the attenuation at higher frequencies prohibits use of those bands, only the first downstream frequency band 200 and first upstream frequency band 202 are utilized. In the event that the attenuation is such that the second downstream frequency band 204 and the second upstream frequency band 206 can be utilized, these bands can support services at those frequencies.

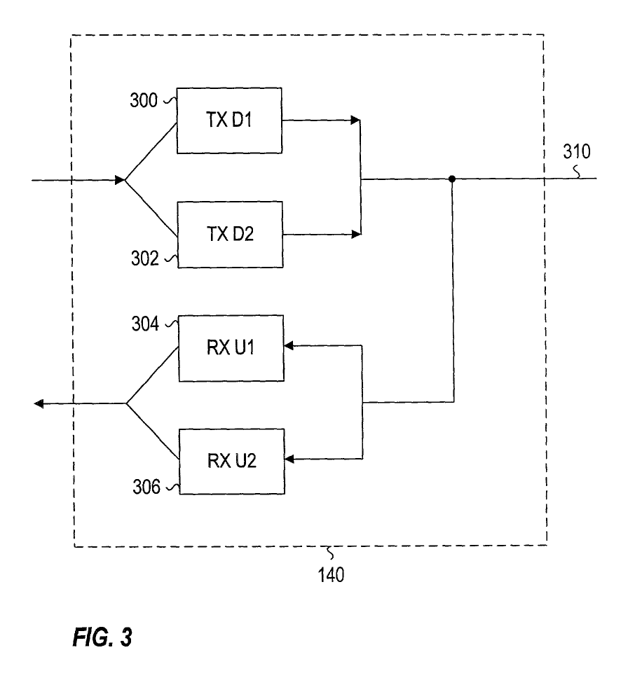

FIG. 3 illustrates one embodiment of the present invention in which a first downstream transmitter 300 is used in conjunction with a second downstream transmitter 302 to transmit on first downstream frequency band 200 and second downstream frequency band 204, respectively. In addition, a first upstream receiver 304 is used in conjunction with a second upstream receiver 306 to receive signals on the first upstream frequency band 202 and second upstream frequency band 206, respectively. A single twisted wire pair connection 310 is coupled to the transceiver unit 140 as illustrated in FIG. 3. When used herein, the term single twisted wire pair connection represents a two wire connection from xDSL transceiver unit central 140. Although not illustrated, a corresponding configuration to that shown in FIG. 3 is used in (XTU_{R}) 150. As can be readily understood, this embodiment allows use of both frequency bands and allows the full bandwidth available in those both frequency bands to be utilized.

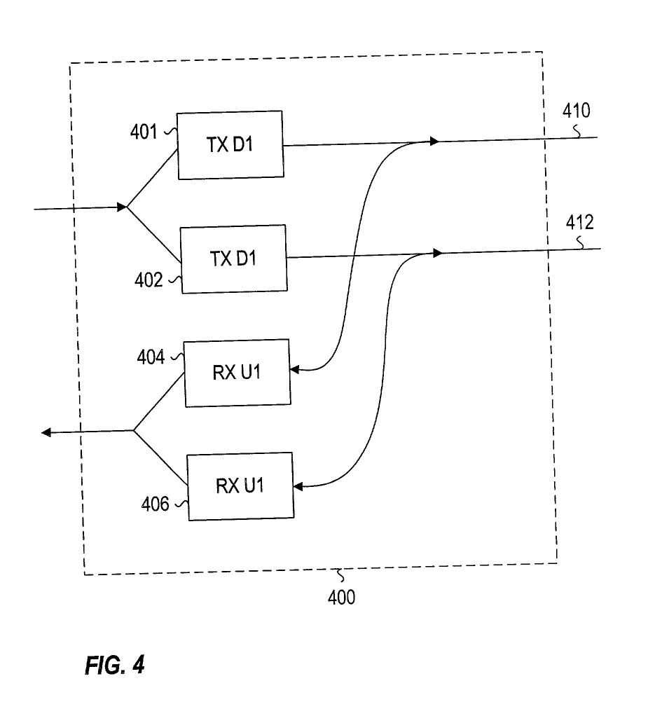

FIG. 4 illustrates an embodiment of the present invention in which first downstream transmitter 300 and second downstream transmitter 302 both utilize the first downstream frequency band 200 on separate twisted pairs connected to first twisted wire pair connection 410 and second twisted wire pair connection 412 respectively. As can also be seen, first upstream receiver 304 and second upstream receiver 306 utilize the first upstream frequency band 202 over two separate twisted wire pair connections connected to first twisted wire pair connection 410 and second twisted wire pair connection 412 respectively. The advantage of this embodiment is that by utilizing only the lower frequency bands, an extended reach for the VDSL system can be achieved. This embodiment makes use of two twisted wire pairs to achieve that transmission and thus requires access to two twisted wire pairs to residence 130. However, in many instances, these twisted wire pairs are available and by utilizing only the lower frequency range in the VDSL spectrum, the extended reach and full service payload can be obtained.

Although this invention has been illustrated by reference to specific embodiments, it will be apparent to those skilled in the art that various changes and modifications may be made which clearly fall within the scope of the invention. The invention is intended to be protected broadly within the spirit and scope of the appended claims.

What is claimed is:

1. A method for providing data service to locations an extended distance from an access network, the method comprising:
generating a downstream signal;
providing the downstream signal to a first transmitter and a second transmitter;
transmitting the downstream signal over media to a location;
generating an upstream signal;
providing the upstream signal to a first receiver and a second receiver; and
receiving the upstream signal over the media from the location.

2. The method of claim 1, wherein said providing includes providing the downstream signal to the first transmitter, the second transmitter or a combination of the first transmitter and the second transmitter.

3. The method of claim 1, wherein said transmitting the downstream signal includes transmitting the downstream signal from the first transmitter, the second transmitter or a combination.

4. The method of claim 3, wherein said transmitting the downstream signal includes transmitting the downstream signal from the first transmitter at a first frequency.

5. The method of claim 3, wherein said transmitting the downstream signal includes transmitting the downstream signal from the second transmitter at a second frequency.

6. The method of claim 3, wherein said transmitting includes transmitting the downstream signal from the first transmitter and the second transmitter over a same twisted wire pair.

7. The method of claim 3, wherein said transmitting includes transmitting the downstream signal from the first transmitter over a first twisted wire pair and transmitting the downstream signal from the second transmitter over a second twisted wire pair.

8. The method of claim 1, wherein said providing includes providing the upstream signal to the first receiver, the second receiver or a combination of the first receiver and the second receiver.

9. The method of claim 1, wherein said receiving the upstream signal includes receiving the upstream signal at the first receiver, the second receiver or a combination.

10. The method of claim 9, wherein said receiving the upstream signal includes receiving the upstream signal at the first receiver at a first frequency.

11. The method of claim 9, wherein said receiving the upstream signal includes receiving the upstream signal at the second receiver at a second frequency.

12. The method of claim 9, wherein said receiving includes receiving the upstream signal at the first receiver and the second receiver over a same twisted wire pair.

13. The method of claim 9, wherein said receiving includes receiving the upstream signal at the first receiver over a first twisted wire pair and receiving the upstream signal at the second receiver over a second twisted wire pair.

14. A transceiver for use in an access network providing data services, the transceiver including:
a media connecting the access network to a location;
a first transmitter for transmitting a first signal at a first frequency;
a second transmitter for transmitting the first signal at a second frequency;
a first receiver for receiving a second signal at a third frequency; and
a second receiver for receiving the second signal at a fourth frequency.

15. The transceiver of claim 14, further comprising means for receiving the first signal.

16. The transceiver of claim 15, wherein the means for receiving routes the first signal to the first transmitter when the media is over a predetermined distance.

17. The transceiver of claim 15, wherein the means for receiving routes the first signal to the second transmitter when the media is under the predetermined distance.

18. The transceiver of claim 15, wherein the means for receiving splits the first signal and routes a first portion to the first transceiver and a second portion to the second transceiver.

19. The transceiver of claim 14, further comprising a combiner for combining an output from the first transmitter and an output from the second transmitter.

20. The transceiver of claim 19, wherein an output from the combiner is transmitted over the media.

21. The transceiver of claim 14, wherein the media includes a twisted wire pair.

22. The transceiver of claim 14, further comprising means for routing the second signal to the appropriate receiver.

23. The transceiver of claim 22, wherein the means for routing routes the second signal to the first receiver when the media is over a predetermined distance.

24. The transceiver of claim 22, wherein the means for routing routes the second signal to the second receiver when the media is under a predetermined distance.

25. The transceiver of claim 22, wherein the means for routing is capable of splitting the second signal and routing a first portion to the first receiver and a second portion to the second receiver.

26. The transceiver of claim 14, wherein the media includes two sets of twisted wire pair.

27. The transceiver of claim 26, wherein an output from the first transmitter is sent over a first twisted wire pair and an output from the second transmitter is sent over a second twisted wire pair.

28. The transceiver of claim 26, wherein an input to the first receiver is received over a first twisted wire pair and an input to the second receiver is received over a second twisted wire pair.

29. The transceiver of claim 14, further comprising a combiner for combining an output of the first receiver and the second receiver.

30. The transceiver of claim 14, wherein the first frequency and the third frequency are the same.

31. The transceiver of claim 14, wherein the second frequency and the fourth frequency are the same.

32. The transceiver of claim 14, wherein the data services are DSL services.

33. The transceiver of claim 14, wherein the transceiver is located either upstream or downstream.

34. A transceiver for providing DSL service over multiple lines or multiple frequencies, the transceiver comprising:
a first transmitter;
a second transmitter;
an input line coupled to said first transmitter and said second transmitter and capable of selectively providing a signal to the first transmitter, the second transmitter, or both the first and second transmitter;
a first transmission line coupled to the first transmitter and capable of being coupled to the second transmitter;
a second transmission line capable of being coupled to the second transmitter;
a switching device for selectively coupling the first transmission line or the second transmission line to the second transmitter;
a first receiver coupled to the first transmission line;
a second receiver selectively coupled to either the first transmission line of the second transmission line; and
an output line coupled to said first receiver and said second receiver and capable of receiving signals from the first receiver, the second receiver or both receivers.

35. The transceiver of claim 34, wherein when the DSL signals are being transmitted over a long distance, the second transmitter and the second receiver will be coupled to the second transmission line.

36. The transceiver of claim 35, wherein the first transmitter, the second transmitter, the first receiver and the second receiver all operate on the same frequency.

37. The transceiver of claim 36, wherein the frequency is a low range frequency.

38. The transceiver of claim 37, wherein the low range frequency is in the approximate range of 0.138 to 3.75 MHz.

39. The transceiver of claim 34, wherein the low range frequency is approximately 0.138 to 3.75 MHz.

40. The transceiver of claim 30, wherein when the DSL signals are transmitted over a short distance, the second transmitter and the second receiver are coupled to the first transmission line.

41. The transceiver of claim 30, wherein the first transmitter and the second transmitter are selectively adjustable.

42. The transceiver of claim 30, wherein the first transmitter transmits at a first frequency and the second transmitter transmits at a second frequency.

43. The transceiver of claim 30, further comprising:
means for determining the frequencies for the first transmitter, the second transmitter, the first receiver and the second receiver; and
means for determining whether to use one or two transmission lines.

44. The transceiver of claim 30, wherein the transceiver provides DSL service to multiple locations.

45. The transceiver of claim 30, wherein the transceiver provides DSL service to multiple locations.

46. The transceiver of claim 30, wherein the first transmitter is a low frequency transmitter and transmits DSL signals to a location which is not in close proximity.

47. The transceiver of claim 30, wherein the first transmitter is a high frequency transmitter and transmits DSL signals to a location which is not in close proximity.

48. The transceiver of claim 24, wherein the first transmission line provides service to one location and the second transmission line provides service to a second location.

49. A method for providing data communications between an access network and remote locations, the method comprising:
receiving a downstream signal;
determining an appropriate frequency for transmission of the downstream signal;
providing the downstream signal to a transmitter cable of transmitting the downstream signal at the appropriate frequency; and
transmitting the downstream signal.

50. The method of claim 46, wherein downstream signals traveling a large distance are transmitted at a lower frequency.

51. The method of claim 46, wherein said determining includes determining that the downstream signal should be transmitted at multiple frequencies.
